(19) United States
(12) Patent Application Publication
(10) Pub. No.: US 2003/0023956 A1
(43) Pub. Date: Jan. 30, 2003

(54) Embedded device monitoring agent

(76) Inventors: Adi Dulberg, Brookline, MA (US); Eldad Maniv, Cambridge, MA (US); Alex Toker, Hagilboa Street (IL); Gil Levonai, Winchester, MA (US)

Correspondence Address: William H Dippert, Reed Smith, 29th Floor, 599 Lexington Avenue, New York, NY, 10022-7650, US

(21) Appl. No.: 10/203,948

(22) PCT Filed: Feb. 14, 2001
(86) PCT No.: PCT/IL01/00142

(51) Int. Cl. G06F 9/44

(52) U.S. Cl. 717/130

(57) ABSTRACT

A generic software logging package (item 13 or FIG. 1) for using with a user software application (12). The software logging package includes at least one function which stores logging data into at least one logging buffer (17) and at least one macro command (20) which expands into a conditional call to the at least one function, the conditional call including a call statement which transfers to the called function at least one redundant parameter.

### RELATED APPLICATIONS

This application claims the benefit under 119 (e) of U.S. provisional patent application No. 60/182,211, filed on Feb. 14, 2000 and U.S. provisional applications Nos. 60/264,729 and 60/264,730, filed on Jan. 30, 2001. This application is a continuation-in-part of U.S. patent application Ser. No. 09/654,925, filed Sep. 5, 2000 and titled “SYSTEM AND METHOD FOR SUPPORT OF EMBEDDED DEVICES”. This application is also related to an application titled “SUPPORT NETWORK”, filed on even date with the instant application as a PCT application in the Israel receiving office, and which designates the US. The disclosures of all of these applications are incorporated herein by reference.

### FIELD OF THE INVENTION

The present invention relates to monitoring and debugging agents for embedded devices.

### BACKGROUND OF THE INVENTION

Embedded processors are employed in many different devices, such as cellular phones, personal organizers, network switches, medical equipment, household appliances (washing machines, televisions), and automobiles. These devices include hardware which is operated by software code run on the embedded processor. During the design, manufacture and/or operation of the devices, it is desired to have the ability to debug and monitor the software code running on the embedded processor.

Generally, when programmers prepare software code for embedded processors they include in the software routines which are used to gather data for debugging. In some cases, various data gathering commands (referred to as hooks) are implanted throughout the software code. During normal operation of the software, the data gathering commands do nothing (except determining that there is no need for data gathering). Under an external command of a maintenance person, however, the data gathering commands are operated and they transmit data to a remote monitoring station. In some systems, the data gathering commands are organized in groups for different purposes. For example, different groups of data gathering commands may be embedded in the software code for use in different failure situations. When a problem arises, the maintenance person generates an appropriate command which awakens a specific group of data gathering commands.

### SUMMARY OF THE INVENTION

An aspect of some embodiments of the present invention relates to generic monitoring software for use with software of embedded devices. The generic monitoring software may be used with substantially any user software and is generally independent of the hardware on which the software is run. The use of a generic monitoring software reduces the time required for programming of software of embedded devices.

In some embodiments of the invention, the generic monitoring software includes a callback function which calls a user defined function. Thus, the generic monitoring software can be used also for activating and/or deactivating user defined functions.

An aspect of some embodiments of the invention relates to a method of coordinating between logging hooks implanted in a software and an agent monitor that displays data provided by the hooks.

In some embodiments of the invention, one or more of the implanted hooks include a function call which has at least one redundant parameter, i.e., not utilized by the called function. The redundant parameter appears in the compiled software in a manner which is easily detectable by the agent manager. In some embodiments of the invention, the compiled software is loaded to the agent monitor, which finds the redundant parameter therein. The agent monitor determines from the redundant parameter and from information from the debugging area of the compiled application, information required in order to display logging data from the hooks and/or other information required in order to interact with the hooks.

Optionally, the redundant parameter comprises a string which, as is known in the art, appears in a static data area of the compiled software. In some embodiments of the invention, the redundant parameter identifies the existence of the hook, the location of the hook within the uncompelled source code, and/or the type of one or more variables to which the hook relates.

An aspect of some embodiments of the invention relates to hooks of an embedded software which may be activated from within the software. For example, in case an error occurs in the embedded device, one or more hooks may be activated by the software in addition to alerting a maintenance person to the error. Thus, logging information is collected at critical times, before the maintenance person has an opportunity to activate hooks. Optionally, the same hooks may be activated both internally from within the software and externally from an agent monitor.

An aspect of some embodiments of the invention relates to a hierarchical method for activating hooks implanted in an embedded software. In some embodiments of the invention, each hook belongs to a group and in addition has its own ID. A hook may be activated by activating its group or by stating that the group is partially activated and activating the specific hook. Optionally, composite groups are defined which allow activation of a plurality of aggregated groups with a single command.

An aspect of some embodiments of the invention relates to multiple-stage methods for activating hooks implanted in an embedded software. The use of multiple-stage activation methods allows a user to control the activation of hooks and/or the performance of some of their tasks from a plurality of different points.

In some embodiments of the invention, one or more hooks do not begin to operate until they are activated both internally and externally. Alternatively or additionally, one or more hooks must be listed at least a predetermined number of times in activation commands in order to be activated. Alternatively or additionally, one or more hooks are pre-activated by a command which states one or more other hooks which are to complete the activation when they are encountered. Further alternatively or additionally, one or more hooks are activated by a command which states an activation time at which the hook is activated and/or a deactivation time at which the hook is deactivated. Further alternatively or additionally, one or more hooks are activated and/or deactivated responsive to empty space in one or more logging buffers and/or responsive to an operation state of a communication link to a remote host. For example, one or more less important hooks may be activated when a logging buffer is relatively empty. These less important hooks are optionally deactivated when the buffer is relatively full so that the data they produce does not take up room which could be used by important hooks.

In some embodiments of the invention, functions called by activated hooks perform their one or more tasks only if one or more conditions are fulfilled. For example, a data logging function may include one or more conditional tasks which are performed only if a link to a host is active or inactive, a buffer has empty space, a previous hook instructed that the conditional task should be performed and/or responsive to any other suitable condition.

An aspect of some embodiments of the invention relates to a logging function library that includes a regular logging function for use in regular code segments and a fast dump function for use in critical code segments. The fast dump function uses a private buffer which does not use semaphores or any other software synchronization mechanism. The regular logging function uses a regular buffer, generally much larger than the private buffer, which is protected by a software synchronization mechanism. Each time the regular logging function is called, it empties data from the private buffer of the fast dump function into its regular buffer, before it stores data in the regular buffer. Thus, the order of the logged data is kept although different buffers are used by the different functions. In addition, only the private buffer of the fast dump function is susceptible to the risk of being used concurrently by two different procedures, while the data in the regular buffer is safe as it is protected by a software synchronization mechanism.

An aspect of some embodiments of the invention relates to a logging function which handles data logged responsive to calls from different hooks, differently. In some embodiments of the invention, the logging function stores data from different sets of hooks in different buffers. Optionally, data logged responsive to calls from hooks activated from within the user software are stored in a first buffer and data logged responsive to calls from hooks activated from a remote host is stored in a second buffer. Alternatively or additionally, the data in the different buffers is provided to a user, differently. For example, data in a first buffer is transmitted over a communication link to the host, while data from a second buffer is stored on a non-volatile storage unit, e.g., a disk.

There is therefore provided in accordance with an embodiment of the invention, a generic software logging package for using with a user software application, including at least one function which stores logging data into at least one logging buffer, and at least one macro command which expands into a conditional call to the at least one function, the conditional call including a call statement which transfers to the called function at least one redundant parameter.

Optionally, the software logging package includes a data transfer agent which transfers data from the at least one logging buffer to a remote host. Possibly, the at least one redundant parameter includes a string parameter which provides information relating to the macro command in an ASCII format. Alternatively or additionally, the at least one redundant parameter includes a parameter which identifies the location of the macro command in the user software application, a variable whose value is to be logged by the at least one function and/or the existence of the macro command in the user software application.

There is further provided in accordance with an embodiment of the invention, a method of preparing a user software application for debugging, including annexing to the user software application at least one function which stores logging data into at least one logging buffer, inserting at least one hook, which includes a call statement to the at least one function, to the user software application, compiling the user software application, and determining one or more parameters of the at least one hook from the compiled user software application.

Optionally, determining the one or more parameters includes determining by a software which does not have knowledge of the format of the results of the compiling of the user software application. Optionally, determining the one or more parameters includes determining a type of a variable whose value is logged by the at least one annexed function.

Possibly, inserting the at least one hook includes inserting a macro. Alternatively or additionally, inserting the at least one hook includes inserting a hook that includes a string which includes information on the hook in ASCII format. Optionally, the at least one hook includes a conditional call to the at least one function, the conditional call includes at least two sub-conditions which depend on respective separate parameters.

Optionally, the at least one function is called by the at least one hook if one of the sub-conditions is fulfilled and/or if both the sub-conditions are fulfilled.

There is further provided in accordance with an embodiment of the invention, a method of preparing a user software application for debugging, including annexing to the user software application at least one function which performs a debugging task, and inserting at least one hook, which includes a conditional call statement to the at least one function, to the user software application, the conditional call includes at least two sub-conditions which depend on respective different parameters.

Optionally, the at least one function is called by the at least one hook if one of the sub-conditions is fulfilled and/or if both the sub-conditions are fulfilled. Optionally, the at least one hook has a unique ID and the at least one of the sub-conditions includes a condition on the unique ID. Possibly, the at least one hook belongs to a group of hooks having a unique group ID and at least one of the sub-conditions includes a condition on the group ID.

There is further provided in accordance with an embodiment of the invention, a method of preparing a user software application for debugging, including annexing to the user software application at least one function which performs a debugging task, inserting, into the user software application, at least one hook, which includes a conditional call statement to the at least one function; and providing a plurality of different functions which actuate the conditional call to call the at least one debugging function.

Optionally, providing the plurality of different functions includes providing a first function which is called from within the user software application and a second function which is called from a host in communication with apparatus running the user software application.

There is further provided in accordance with an embodiment of the invention, a method of preparing a user software application for debugging, including annexing to the user software application at least one debugging function which performs a debugging task, inserting, into the user software application, at least one debugging hook that includes a conditional call to the at least one debugging function, annexing to the user software application at least one actuation function which changes a value of at least one condition parameter on which the condition of the at least one debugging hook depends, and inserting, into the user software application, at least one actuation hook which calls the actuation function.

Optionally, the at least one actuation hook conditionally or unconditionally calls the actuation function. Optionally, the at least one actuation function receives a condition which controls the time at which the value of the at least one condition parameter is changed. In some embodiments of the invention, the at least one debugging function includes one or more debugging tasks which are performed only in some of the times in which the debugging function is called. Optionally, the at least one actuation function receives a condition which controls the operation periods of the one or more debugging tasks. Possibly, the received condition includes a condition which depends on whether the user software application encountered one or more hooks inserted into the user software application.

Optionally, the received condition includes a condition which depends on whether the user software application encountered the one or more specific hooks after the debugging hook was activated. Optionally, the debugging function includes a logging function.

Optionally, the received condition includes a condition which depends on the contents of one or more buffers in which the logging function writes data, on whether the one or more buffers are full and/or on an activation state of a link between a processor running the user software application and a remote host. Optionally, the method includes changing the value of the condition parameter by an external user.

Possibly, the debugging function operates differently depending on whether the change of the value of the condition parameter was caused by the external user or by the actuation function. Optionally, the different operation includes the identity of one or more buffers to which the debugging function writes logging data.

There is further provided in accordance with an embodiment of the invention, a method of preparing a user software application for debugging, including annexing, to the user software application, a first logging function which is adapted to store logging data in a first buffer, and annexing, to the user software application, a second logging function adapted to transfer any data in the first buffer to a second buffer and then store logging data in the second buffer. Optionally, access to the first buffer is not protected by a software synchronization mechanism. Optionally, the size of the first buffer is not greater than 40 bytes.

There is further provided in accordance with an embodiment of the invention, a method of preparing a user software application for debugging, including annexing to the user software application at least one debugging function which performs a debugging task, inserting, into the user software application, at least one debugging hook that includes a conditional call, which depends on a debugging condition variable, to the at least one debugging function, annexing to the user software application at least one callback function which calls a user defined function, inserting, into the user software application, at least one callback hook that includes a conditional call, which depends on a callback condition variable, to the at least one debugging function, and providing at least one routine adapted to change both the callback condition variable and the debugging condition variable.

Optionally, the at least one routine changes the debugging condition variable and the callback condition variable substantially concurrently. Alternatively or additionally, the at least one routine changes at a specific routine call, one of the debugging condition variable and the callback condition variable. Possibly, the at least one routine changes the debugging condition variable and the callback condition variable responsive to commands from a remote host.

Optionally, the at least one routine changes the debugging condition variable and the callback condition variable responsive to commands annexed to the user software application.

There is further provided in accordance with an embodiment of the invention, a method of changing the value of a portion of a complex variable in a process running on an embedded device, from a remote host, including providing a new value to which the portion of the complex variable is to be changed, encapsulating the new value in a data structure of the size of the complex variable, generating a mask which identifies the areas in the data structure which include the new value, transmitting the data structure and the generated mask to the embedded device, and changing the value of the portion of the complex variable responsive to the data structure and the mask.

Optionally, changing the value of the portion of the complex variable includes performing an AND operation between the mask and the complex variable.

There is further provided in accordance with an embodiment of the invention, a method of changing, substantially simultaneously, the value of a plurality of variables of a plurality of different processes executed by a processor, including providing respective values to be assigned to the plurality of variables, to the processor, calling a value assignment function from a first one of the processes, stalling the first process until all the other processes call the assignment function, assigning the transmitted values to their respective variables, and terminating the stalling of the first process.

Optionally, assigning the value of the variable in the first process is performed before the first process is stalled and/or after the stalling of the first process is terminated. Possibly, providing respective values to the processor includes transmitting the values to the processor from a remote host.

There is further provided in accordance with an embodiment of the invention, a method of logging data of a software application on an embedded device, including calling a logging function from one or more first hooks in the software application, storing, by the logging function, logging data in a first buffer responsive to the call from the one or more first hooks, calling the same logging function from one or more second hooks in the software application; and storing logging data, by the same logging function, in a second buffer responsive to the call from the one or more second hooks.

Optionally, the first and second hooks are activated by different respective software routines. Possibly, the first hooks are activated responsive to a command annexed to the software application and the second hooks are activated responsive to commands from a remote host. Optionally, the method includes providing at least some of the data from the first and second buffers to a user, using different respective methods. Possibly, the different methods used to provide data from the respective buffers to the user differ in the link used to provide the data. Optionally, the data from the first buffer is stored in a non-volatile memory and the data from the second buffer is provided over a communication link to a remote host. In some embodiments of the invention the method includes calling a logging function from one or more third hooks in the software application and storing, by the logging function, logging data in one or more additional buffers responsive to the call from the one or more third hooks.

There is further provided in accordance with an embodiment of the invention, a method of logging data of a software application on an embedded device, including calling a logging function from a hook in the software application and storing, by the logging function, identical copies of logging data in a plurality of buffers responsive to the call from the hook. Optionally, storing the data includes storing in a plurality of buffers located in a single memory unit.

### BRIEF DESCRIPTION OF FIGURES

Exemplary non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 is a schematic block diagram of an embedded device and a monitoring system therefore, in accordance with an embodiment of the present invention;

FIG. 2 is an exemplary illustration of a hook of a monitoring system, in accordance with an embodiment of the present invention;

FIG. 3 is a flowchart of the acts performed in using a software application including monitoring hooks, in accordance with an embodiment of the present invention;

FIG. 4 is a schematic illustration of the contents of a logging buffer area, in accordance with an embodiment of the present invention; and

FIG. 5 is a schematic block-diagram illustration exemplary code appearing in a software application and data flow relating thereto, in accordance with an embodiment of the present invention.

### DETAILED DESCRIPTION OF EMBODIMENTS

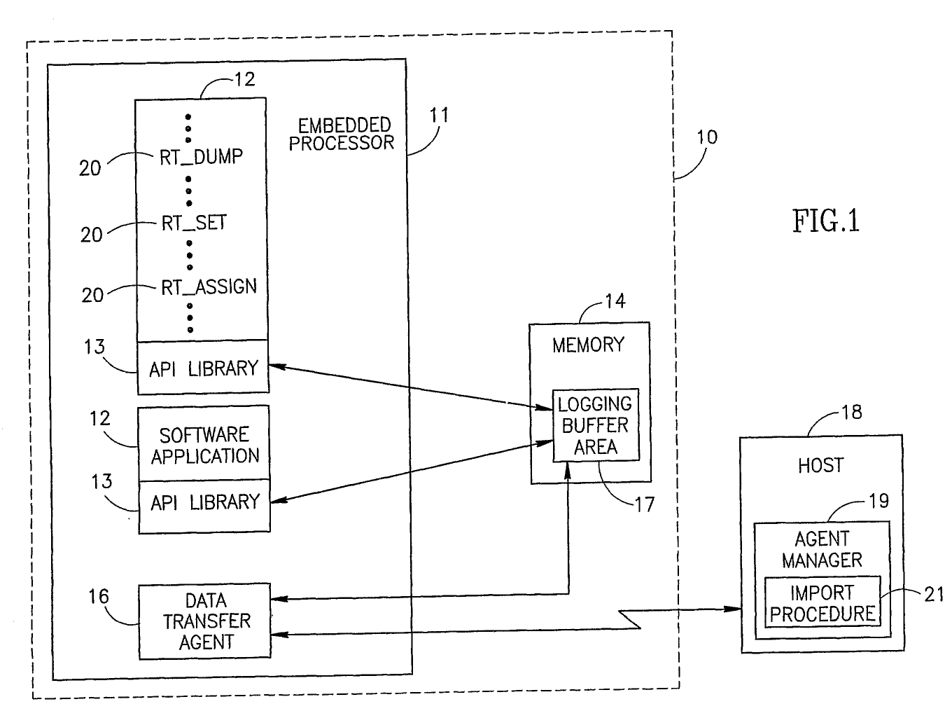

FIG. 1 is a schematic block diagram of an embedded device 10 and a monitoring host 18 therefore, in accordance with an embodiment of the present invention. Embedded device 10 comprises an embedded processor 11 which runs one or more software applications 12, which generally utilize a memory 14. Software applications 12 may comprise, for example, an executable code, a DLL (dynamic link library) or any other program module. Software application 12 may comprise substantially any type of task, including an operating system (OS), application modules and communication clients and servers.

In some embodiments of the invention, a generic logging software package which may operate with substantially any embedded software application 12, is used for performing debugging, monitoring and/or logging operations. The use of a generic logging software package generally reduces the software development costs of software application 12. Generally, the logging software package is platform independent, i.e., does not depend on the hardware of embedded processor 11.

In some embodiments of the invention, the logging software package comprises an agent application programming interface (API) library 13 which contains generic functions for performing logging operations as described hereinbelow. The functions in API library 13 generally reference one or more buffers in a logging buffer area 17. In some embodiments of the invention, each software application 12 on embedded processor 11 includes a separate copy of API library 13. Alternatively or additionally, one or more of software applications 12 share a single copy of API library 13 or of portions thereof.

The logging software package optionally further comprises a data transfer agent 16 which exports logging information from logging buffer area 17 to an external host 18 and/or to other monitoring devices or storage media. In some embodiments of the invention, data transfer agent 16 is run on embedded processor 11. Alternatively, data transfer agent 16 is run on a separate processor, optionally a direct memory access (DMA) unit. Optionally, host 18 runs an agent manager 19 which displays logging data from embedded processor 11 and/or allows a maintenance person to interact with the logging software package. Alternatively, agent manager 19 runs on embedded processor 11, and data transfer agent 16 performs processor-internal data transfer tasks.

In installing the generic logging software package, a programmer of software application 12, plants logging instructions (referred to herein as hooks 20) within software application 12. Generally, hooks 20 are distributed throughout software application 12 in its various procedures. Hooks 20 generally access procedures in API library 13, which procedures perform various logging tasks. In some embodiments of the invention, at least some of hooks 20 are not always active. Thus, a large number of hooks 20 may be distributed throughout application 12 without a user having to receive data from all of the hooks and being overwhelmed by the data which all the hooks generate. Instead the user may activate only some of the hooks, as described hereinbelow.

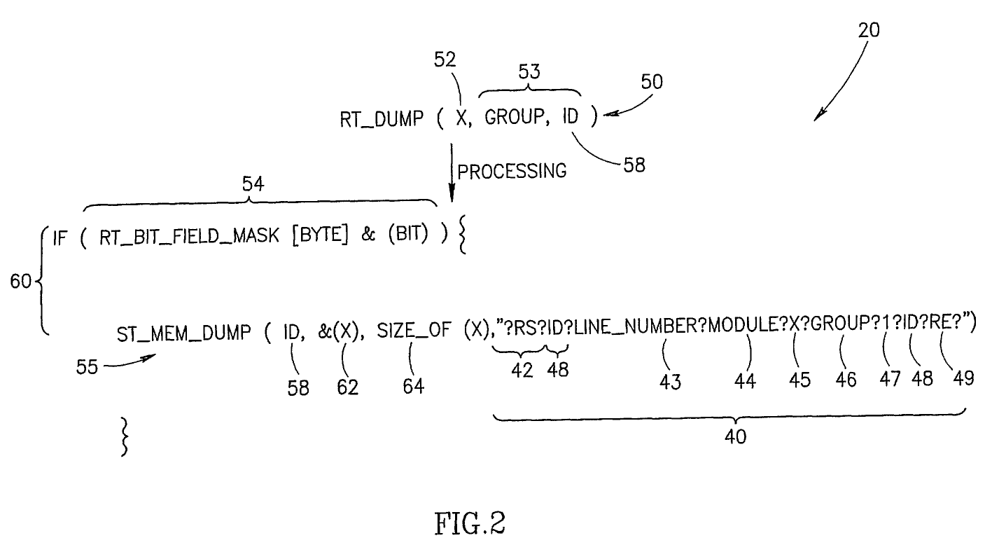

FIG. 2 is an exemplary illustration of a hook 20, in accordance with an embodiment of the present invention. Hook 20 is inserted into software application 12 in the form of a short macro command 50, which has one or more command-specific parameters 52 (the number of which generally differs according to the specific hook type), and one or more hook identification fields 53, which uniquely identify the hook 20 within software application 12.

In the example shown in FIG. 2, hook 20 comprises an RT_DUMP command which dumps the value of a parameter (e.g., X) to logging buffer area 17. The exemplary command RT_DUMP has a single command-specific parameter 52 which identifies the parameter whose value is to be dumped. As shown, hook identification fields 53 comprise a GROUP parameter which identifies a group to which the specific hook 20 belongs, and a hook ID parameter 58 which identifies the specific hook 20 within its group.

During compilation (i.e., pre-processing) of software application 12, macro command 50 is expanded into a IF command 60 which is formed of a condition 54 and a function call 55. During the running of software application 12, condition 54 checks whether the hook 20 is active, as described hereinbelow. If the hook 20 is active, function call 55 calls a library function (in the figure ST_MEM_DUMP) which performs the task of hook 20. In some embodiments of the invention, the parameters of function call 55 include the hook ID (parameter 58 from identification field 53), the parameters 52 of the specific hook type (using any suitable method, e.g., passing for each parameter its address 62 and length 64, determined, for example, using the sizeof function), and a string 40.

In some embodiments of the invention, the transfer of string 40 in function call 55 is not required for the operation of the called function. Rather, the contents of string 40 are used by an external application, e.g., agent manager 19, to identify the hook and/or determine one or more parameters of the hook, as is now described.

In some embodiments of the invention, string 40 comprises a concatenation of a plurality of fields delineated by one or more separation characters, e.g., “?”.

In some embodiments of the invention, string 40 comprises an ASCII ID string 48 containing the ID of the hook as stated in ID parameter 58. Optionally, ID string 48 appears twice in string 40, at the beginning and end of the string, allowing simple identification of string 40 based on the ID strings 48 of the string 40. Alternatively or additionally, string 40 comprises a type field (not shown) which indicates the type of function called by the hook. For example, the type field may include a single letter, e.g., D for dump, E for event, etc. In addition, string 40 optionally comprises one or more fields which convey information related to the hook to agent manager 19. In some embodiments of the invention, string 40 comprises a string 43 which states the line number of hook 20 in the code of application software 12, and/or a module string 44 which states the name of the module or file in which hook 20 resides. Alternatively or additionally, string 40 comprises group fields, e.g., a group name field 46 and a group number field 47, which identifies one or more groups to which hook 20 belongs as stated in parameters 53 of macro command 50. Further alternatively or additionally, string 40 comprises one or more strings 45 which state the names of the command-specific parameters 52 referenced by hook 20.

Optionally, string 40 includes beginning and/or ending identification strings (42 and 49, respectively) which are used to identify the beginning and/or end of string 40. For example, string 42 may be RS which stands for ‘start’ and ending string 49 may be RE which stands for ‘end’. Identification strings 42 and 49 are optionally used together with ID strings 48 in identifying strings 40. It is noted, however, that other identification strings may be used, for example strings selected as having low chances of appearing by chance, optionally using longer strings and/or rarer characters. In some embodiments of the invention, the contents of string 40 or of one or more sub-strings therein are encrypted, to prevent extracting logging information by hosts which do not have a decryption key.

In some embodiments of the present invention, the unique IDs 58 are of a sufficient size to allow assigning a unique ID to each hook 20 in software application 20. Alternatively or additionally, unique IDs 58 are larger than required to encode the largest number of hooks 20 possibly included in software application 12, for example so as to allow for inclusion of random-number and/or time dependent redundancy in the IDs 58. In an exemplary embodiment of the invention, ID 58 is 32 bits in length.

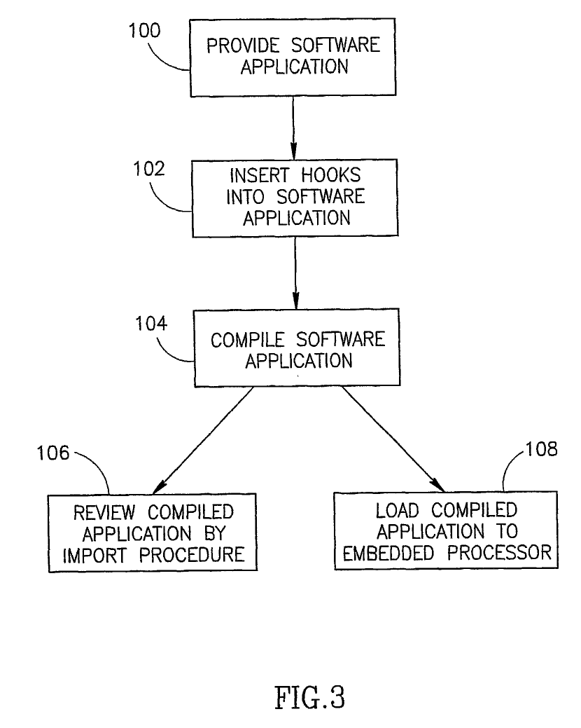

FIG. 3 is a flowchart of the acts performed in using a software application 12, in accordance with an embodiment of the present invention. In step 100, a software application 12 is provided. Optionally, a programmer or a maintenance person of software application 12 inserts (102) hooks 20 throughout software application 12. In some embodiments of the invention, the programmer selects the ID parameters 58 of the hooks 20. Alternatively, macro commands 50 generate the hook IDs automatically. Further alternatively, the programmer inserts the hooks with a wild card mark which is automatically filled in by a pre-preprocessing program, for example executed on host 18. The IDs of the hooks may be filled in randomly or using consecutive numbers. Alternatively or additionally, the ID of a hook 20 is selected at least partially as a function of the location of the hook within the code of software application 12, the parameters 52 passed by the hook, the function called by the hook (e.g., using a hash function) and/or as a function of other information relating to the hook. Optionally, information encoded within the hook ID is not included in string 40.

After the hooks 20 are inserted into software application 12, the software is compiled (104). Optionally, software application 12 is compiled with a copy of API library 13, for example using an “include” command. As is known in the art, the compiling of software application 12 places the strings 40 included in the code of the application in a static data area of the compiled application.

In some embodiments of the invention, the compiled application 12 is reviewed (106) by an import procedure 21 of agent manager 19. Import procedure 21 finds strings 40 within the compiled application and uses their contents to create a table which correlates between hook IDs and information related to the hooks. Optionally, for each hook 20, import procedure 21 determines the location of the hook within the code from strings 43 and 44 (FIG. 2). In addition, import procedure 21 determines the variable to which the hook relates from string 45. Optionally, import procedure 21 consults the debugging area of the compiled application to determine the type and/or structure of the variable to which the hook relates. The use of stings 40 simplifies the access to the debugging area of the compiled application and allows determining the variable type even when the format of the debugging area of a specific compiler used, is not known. Alternatively or additionally, string 40 is not used and import procedure 21 extracts the variable type information directly from the debugging area of the compiled application based on knowledge of the format of the compiled code which is used. For example, import procedure 21 may identify the function calls to the functions of library 13.

The compiled application 12 is loaded (108) to embedded processor 11, before, after or in parallel with the operation of import procedure 21.

During the operation of software application 12, functions of API library 13 dump data into logging buffer area 17. The data dumped into logging area 17 is optionally accompanied by the hook ID which caused its dump. The dumped data is generally transferred to agent manager 19. Agent manager 19 receives the data with the hook ID and, using the respective information in the table prepared by import procedure 21, displays the data, preferably in a user friendly manner. For example, the information in the table may indicate the data type of the dumped data.

Alternatively, to using the table from import procedure 21, the functions in library 13 dump the data with all the information required by agent manager 19 for displaying the data.

In some embodiments of the invention, during the operation of software application 12, a maintenance person may use agent manager 19 to activate and/or deactivate hooks 20. Optionally, agent manager 19 includes a user interface, e.g., a graphic user interface (GUI), which aids the maintenance person in selecting the hooks 20 to be activated. For example, the interface of agent manager 19 may display the code of software application 12, allowing the maintenance person to click on hooks which are to be activated. Alternatively or additionally, the maintenance person may indicate a predefined group of hooks 20 which are to be activated. Agent manager 19 optionally consults the table generated by import procedure 21 to determine which hooks belong to the indicated group. Alternatively, agent manager 19 transmits the name of the predefined group to agent 16. Optionally, one or more hooks may be included in a plurality of different predefined groups. Alternatively or additionally, one or more hooks are not included in any group.

Alternatively or additionally to reviewing the compiled application by import procedure 21, the tasks of import procedure 21 are performed by an initialization function in library 13 which is run, for example, at start-up of processor 11. Optionally, the function scans the compiled application and accordingly determines the variable types of the hooks. The variable types are then transferred to agent manager 19. Alternatively or additionally, at startup and/or upon a request from host 18, the compiled code of software application 12 (optionally without library functions 13) is exported to host 18 for review by import procedure 21. In some embodiments of the invention, the debugging information of the compiled application is loaded into embedded processor 11 so that it is available for use and/or transmission to host 18.

In some embodiments of the invention, the interface of agent manager 19 allows the maintenance person to control the display of the dumped data, for example using different colors and/or sizes for data of different hooks or groups.

It is noted that in the example of FIG. 2, described above, the host ID parameter 58 identifies the specific hook even without the value of the group parameter. Alternatively, the same ID may be used in different hook groups to identify different hooks. In this alternative, the parameters of function call 55 optionally include all the identification parameters 53 from macro command 50. Further alternatively, hook identification fields may include more or fewer parameters. Further alternatively or additionally, some hooks may use only a group ID.

In some embodiments of the invention, instead of using strings 40 to convey information relating to the hooks to agent manager 19, the information is provided to agent manager 19 by the pre-preprocessing program.

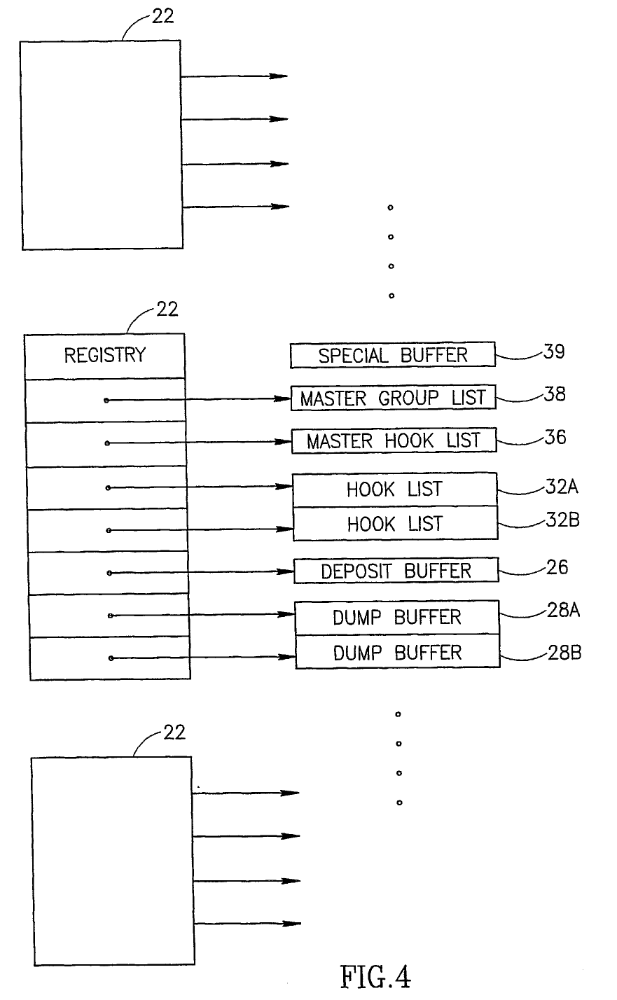

FIG. 4 is a schematic illustration of the contents of logging buffer area 17 in memory 14, in accordance with an embodiment of the present invention. Logging area 17 optionally comprises, for each software application 12, a respective registry record 22 which states the locations of the remaining elements of logging area 17 relating to the software application 12. The data in registry records 22 is used by agent 16 and/or the functions of library 13 to find the elements of logging area 17 which they need. Optionally, registration records 22 also list for each software application 12 the process ID, application name, and/or version of the application. Optionally, this information is transferred to agent manager 19 for use in identifying from which application logging data is received.

Optionally, logging area 17 includes for each software application 12 an input deposit buffer 26 which is used to transfer data from agent manager 19 to the logging software package. Agent 16 stores the data in deposit buffer 26, and user application 12 retrieves the data as described hereinbelow.

Alternatively or additionally, one or more of the elements of logging area 17, e.g., one or more of buffers 28, buffer 26 and/or hook lists 32, are common to a plurality (e.g., all) of software applications 12. In some embodiments of the invention, a common deposit buffer 26 is used for a plurality of applications 12. Optionally, a user may transmit, from agent manager 19 to agent 16, a plurality of variable values for respective different applications, with an indication that the update must be performed concurrently. When the variable update API function (e.g., RTassign) is called from the first application 12, the function does not return control to the application until the function is called by all the other applications and their variables are updated. Only after all the variables are updated, the control is passed back to all of the user software applications 12.

In some embodiments of the invention, logging area 17 includes one or more buffers 28 (marked 28A and 28B) in which logging data from software application 12 is dumped by hooks 20 (FIG. 1) located therein. For each dump buffer 28, logging area 17 includes a respective hook list 32 (marked 32A and 32B) which states for each hook 20 whether it is operative with relation to respective buffers 28. Optionally, hook lists 32 list the hook IDs of the hooks 20 which are active. In some embodiments of the invention, logging buffer area 17 includes a master hook list 36 which combines the information in hook lists 32. That is, in these embodiments, each hook 20 is listed in master hook list 36 as active if it is listed as active in at least one of hook lists 32.

During execution of software application 12, generally each time a hook 20 is reached, the if condition 54 (FIG. 2) of the hook 20 references (for example as described below) master hook list 36 to determine whether to perform the function call 55 of the hook (i.e., the hook is active). If the hook 20 is not listed as active, the software application 12 continues in its normal flow. If, however, the hook 20 is listed as active in master hook list 36, the function call 55 of the hook is performed and control is transferred to the respective function in API library 13. If the called function relates to dumping data, the function optionally refers to lists 32 to determine in which lists the hook 20 calling the function is active, and accordingly determines to which one or more buffers 28 the dumped data is to be placed.

In some embodiments of the invention, master hook list 36 is implemented using a bit array in which each hook 20 (identified by a unique ID) corresponds to a specific location in the bit array.

Referring back to condition 54 in FIG. 2, condition 54 checks the bit array (named RT_BIT_FIELD_MASK) to determine whether the bit corresponding to the current hook is set. In some embodiments of the invention, RT_BIT_FIELD_MASK is an array of bytes in which a particular bit is referenced using a BYTE index which points to the specific byte including the desired bit and using a bit mask BIT which chooses the specific bit within the referenced byte. In compiling macro command 50 into IF command 60, the hook ID 58 of the specific hook 20 is translated into a pair of values of BIT and BYTE which uniquely correspond to the value of the ID 58 of the hook. The size of RT_BIT_FIELD_MASK is optionally determined according to the maximal possible number of hooks included in a software application 12, for example, 8K bits. The use of a bitmask allows relatively fast determination of whether a hook 29 is operative.

In some embodiments of the invention, the mapping function between IDs 58 and BYTE, BIT pairs comprises a hashing function. In an exemplary embodiment of the invention, in which master hook list comprises a bit mask array of 1024 bytes, BYTE=((ID>>3) & ((1<<10)−1)) and BIT=1<<((ID) & 0×7)) where the << operator indicates left shift and the >> operator indicates right shift. The term & ((1<<10)−1) performs a modulo operation with the size of the bit array. Alternatively, any other mapping function, for example a function performing a simple modulo operation, is used.

In some embodiments of the invention, the activity of hooks 20 which do not use any of buffers 28 is indicated only in master hook list 36 and not in hook lists 32.

Alternatively to condition 54 referencing master hook list 36, condition 54 and/or one or more of the functions in library 13 reference each of hook lists 32 to determine if the hook is active in one of hook lists 32. Optionally, lists 32 are also implemented using bit arrays. Alternatively, hook lists 32 are implemented as linked lists with pointers from registry record 22 to the head of each list. Further alternatively or additionally, master hook list 36 is implemented using a linked list of hook IDs.

In some embodiments of the invention, logging area 17 includes, in addition to master hook list 36 which relates only to each hook on its own, a master group list 38 which relates to groups of hooks together. Optionally, in order to activate a group of hooks 20 together, an ID of the group is added to master group list 38. In these embodiments, condition 54 optionally comprises a multiple condition which checks both master hook list 36 and master group list 38. Optionally, the function referenced by the hook is called if the hook is active in either master hook list 36 or in master group list 38. Alternatively, condition 54 first checks the group list 38 which has three states, namely all active, partially active and inactive. If the group of the hook is in the “all active” state, the function is immediately called without checking master hook list 36. If the group of the hook is in the partially active state, the bit corresponding to the hook is checked in master hook list 36 and accordingly it is determined whether to call the function in the hook. If the group list 38 is in the inactive state the flow in software application state continues without further checks.

In some embodiments of the invention, group list 38 is implemented using a pair of bitmasks, one bitmask being set if the group is always active and the other bitmask being set if the group is partially active. Optionally, a predetermined group number designates hooks which are always active. Alternatively or additionally, a second predetermined group number designates hooks whose group is always partially active, i.e., an omnibus group. In some embodiments of the invention, the group of each hook is identified by a 32 bit variable. Optionally, eight of the bits of the variable (e.g., the least significant bits or the most significant bits (MSB)) are used to designate the group number, i.e., as an index to the bitmasks. In some embodiments of the invention, one or more of the other bits of the variable are used to designate special groups. For example, the MSB may be set when the group is always all active.

In some embodiments of the invention, a hook may be included in a plurality of groups. As long as one of the groups is active, the hook is considered active.

In some embodiments of the invention, instead of master hook list 36 indicating the combination of the activated hooks in all of hook lists 32, the hooks indicated as active in master hook list 36 are from one or more specific lists 32 which are selected according to one or more predetermined parameters. Optionally, each list 32 has an associated priority and the hooks listed in master hook list 36 are from lists 32 having a highest priority. Alternatively or additionally, the specific lists 32 which affect the contents of master hook list 36 are selected responsive to one or more storage and/or transmission related parameters, such as whether a link to host 18 is operative, the size of buffers 28 and/or the empty space in buffers 28.

In an exemplary embodiment of the invention, memory 14 comprises only a single buffer 28, but includes two lists 32, a host list (which is changed by commands from host 18) and a code list (which is changed by commands from within software application 12). The contents of master hook list 36, and hence which hooks are actually active, follows one of lists 32, depending on whether a connection to host 18 is operable. Thus, the control of the activity of hooks 20 has additional flexibility. In some exemplary embodiments of the invention, when host 18 is not connected to the embedded device, data is collected according to internal settings of the code list. When host 18 connects to the embedded device, data is collected according to a host list with settings from the host.

API Functions

Referring in more detail to the functions in API library 13, in some embodiments of the invention, the functions include one or more dump functions which pass values of logged functions from the running application 12 to one or more of buffers 28. In an exemplary embodiment of the invention, the dump functions comprise an RTdump function which exports application data structures, an RTevent function which exports an indication that the hook was reached with or without a time stamp and an RTstr function which exports user-defined strings. Optionally, each dump function receives a single parameter 52 which is the variable whose contents the function dumps into the one or more buffers 28. Alternatively or additionally, one or more of the dump functions may receive a plurality of variables which it is to dump. In this alternative, the function specific parameters 52 may include a parameter which indicates the number of variables whose values are to be dumped.

Alternatively or additionally, a function in library 13 is used to define groups of variables. Such groups of variables may be used, for example, in a hook call to RTdump. During the running of software 12 the variables in the group may be changed from within the application and/or from agent manager 19.

Alternatively or additionally to the IF condition 54 (FIG. 2) of the RTassign macro determining if to call the respective API function based on whether the hook 20 is active, condition 54 determines whether their is data waiting for the function in deposit buffer 26. Optionally, a deposit bitmask contains a bit, which designates whether data has been received, for each RTassign hook 20 in software application 12. When agent 16 places data in buffer 26 the respective data to the hook (or hooks which may collect the data) is set and when the data is collected by the RTassign function, the respective bits are reset.

In some embodiments of the invention, when one of the dump functions (e.g., RTdump) is called, the function first determines for which buffers 28, the hook 20 which called the dump function is active. The variables referenced by the function call are dumped into each of the buffers 28 for which the calling hook 20 is active. The use of a plurality of buffers 28 allows, for example, gathering of different data sets, simultaneously. For example, a first maintenance person may require data relating to a first technical aspect (e.g., electric aspects), while a second maintenance person may require data related to a second technical aspect (e.g., mechanical aspects). Alternatively or additionally, one or more of buffers 28 (referred to herein as a host buffer) collects data requested by agent manager 19, while one or more buffers 28 (referred to herein as a code buffer) collect data under the initiative of one or more hooks 20 within software application 12.

In some embodiments of the invention, API library 13 comprises a fast dump function which dumps data very fast. The fast dump function may be used, for example, in interrupt service routines (ISR) and/or in functions which cannot include semaphores. Optionally, a special buffer 39 (e.g., a FIFO buffer or any other type of buffer) is defined in logging area 17 for dumping data of the fast dump function. Special buffer 39 is optionally very short, for example between about 2-10 words of 32 bits. Optionally, each software application 12 has a separate special buffer 39. Alternatively, a single special buffer 39 services all of software applications 12. Optionally, the fast dump function may dump only up to a predetermined amount of data, possibly less than half or a fourth of the capacity of buffer 39.

In some embodiments of the invention, each time a regular dump function is called, it checks whether data has been recently entered to special buffer 39. If data was recently entered to special buffer 39, the dump function copies the data into one or more regular buffers 28 and erases the indication that data was entered to special buffer 39. In some embodiments of the invention, the data from special buffer 39 is transferred to one or more predetermined buffers 28. Alternatively, the data in special buffer 39 includes the hook ID of the hook which entered the data and the regular dump function checks this hook ID against hook lists 32 to determine to which buffers 28 the data should be copied.

Optionally, library functions 13 also include a value assigning function, (e.g., RTassign), which checks in deposit buffer 26 whether a value for a specific parameter 52 of the function was received. A maintenance person may enter, to agent manager 19, a value to be assigned to a variable of software application 12. Optionally, import procedure 21 generates a list of variables for which RTassign hooks were implanted in software application 12 and/or a list of the hooks and their locations. A maintenance person selects from this list and assigns the variable a value. Optionally, the maintenance person may indicate one or more specific hooks which are to assign the value to the variable. The value is then transferred to buffer 26, together with the name of the variable and/or the hook ID of the hook at which the value is to be assigned. When RTassign is called, it is called with a parameter which indicates the variable which is to receive the value. The RTassign searches through buffer 26 for the variable name and/or the hook ID of the hook calling RTassign and if buffer 26 carries a value for the variable, the value is assigned to the variable. Otherwise, software application 12 continues with normal operation using the current value of the variable.

In some embodiments of the invention, the RTassign function may be used to change a portion of a complex data structure variable. Optionally, along with the new value of the variable, agent manager 19 places, in buffer 26, a bitmask which indicates those areas of the complex variable which are to be changed. Using a bitmask allows much faster performance than accessing by name a specific field of a complex variable. Alternatively or additionally, RTassign accesses a specific field of the complex variable using standard indexing methods.

In some embodiments of the invention, API library 13 includes control functions which control the operation of one or more of the other functions in library 13. Optionally, API library 13 includes a filter setting function (RTsetFilter) which manipulates one or more of lists 32 and master list 36. In some embodiments of the invention, the RTsetFilter function changes one or more predetermined filters 32 which affect one or more respective buffers 28 (e.g., the code buffer) and accordingly also changes master list 36. Alternatively or additionally, the RTsetFilter function receives, as a parameter, which of lists 32 are to be changed.

In some embodiments of the invention, at start-up of software application 12, an initialization function is run, which function defines a plurality of predetermined filter lists. Alternatively or additionally, the predetermined filter lists are defined as constants or regular variables which may be changed using standard programming methods. RTsetFilter receives as a parameter a pointer to one of the predetermined filter lists and this list replaces the current filter list. Alternatively or additionally, the RTsetFilter function, or any other API library function, is used to add or remove one or more filters from one or more of the filter lists. Further alternatively or additionally, other functions are included in API library 13, such as those described hereinbelow.

In some embodiments of the invention, API library 13 includes a callback function which is used to call a user written function, by a hook 20. Such user functions may include SNMP traps, buffer uploading to a server or any other user defined function. In some embodiments of the invention, the callback function receives as a parameter a pointer to the user function. The callback function allows use of the hook activation system to activate user functions.

In some embodiments of the invention, API library 13 includes a multiple call macro which calls a plurality of API functions responsive to a single condition. Thus, when the hook is not active, it utilizes time for a single condition and not of a plurality of conditions.

Control of Logging from Agent Manager

In some embodiments of the invention, a user of host 18 may enter to agent manager 19 commands which affect the operation of the logging software package on embedded processor 11. Optionally, as described above, agent manager 19 includes a user interface which allows the user to select which hooks are to be active. In some embodiments of the invention, agent manager 19 defines a plurality of predefined sets of hooks from which the user selects a specific set which defines which hooks are currently active. Alternatively or additionally, the user may point at a specific hook and activate or deactivate that hook. Optionally, responsive to the user changes of active hooks, agent manager 19 transmits to agent 16 a new list of hooks for one or more of hook lists 32. Alternatively, agent manager 19 transmits to agent 16 commands on how to change one or more of hook lists 32. According to the changes in the one or more hook lists 32, agent 16 automatically updates master hook list 36. Alternatively, agent manager 19 transmits to agent 16 commands on how to change master hook list 36 together with the commands on changing the one or more hook lists 32.

In some embodiments of the invention, activation commands, e.g., user commands from agent manager 19 and/or RTsetFilter commands, may select when the active hook changes are to go into effect. Optionally, the activation commands include a parameter (“start collection”) which indicates when the changes in hook activation take effect. Optionally, the start collection parameter may indicate that the changes should immediately go into effect, that the changes should go into effect after a predetermined time, that the changes should go into effect at a certain time and/or that the changes should go into effect responsive to a software trigger within software application 12. Optionally, API library 13 includes a specific command which serves as a software trigger for activation completion of pre-activated hooks. Alternatively or additionally, substantially any hook in software application 12 may serve as a software trigger.

In some embodiments of the invention, the user may select when the active hook changes are to become ineffective. Optionally, the activation commands include a parameter (“end collection”) which indicates when the effect of the changes is to end. Optionally, the end collection parameter may indicate that the changes should continue to be in effect until a contradicting command is received from agent manager 19, that the changes should terminate after a predetermined time, that the changes should terminate at a certain time and/or that the changes should terminate responsive to a software trigger within software application 12. Alternatively or additionally, the end collection parameter may receive a “Buffer Full” value which indicates that the changes should be in effect until the data they collect fills the buffer. Further alternatively or additionally, the end collection parameter may receive a data amount value which indicates that the effect of the changes should be terminated when a given amount of data is collected and/or after a hook is passed a predetermined number of times.

In some embodiments of the invention, one or more of the functions in API library 13 perform one or more of their tasks conditionally, based on one or more control states. Thus, an additional control level is provided, in addition to the control levels included in activating hooks 20 which call the functions. For example, a data logging function (e.g., RTdump) may collect data only if the condition is fulfilled or may place the data in different locations responsive to different control states.

In some embodiments of the invention, some or all of the hook activation commands (e.g., RTsetFilter commands and/or commands from agent 19), identify the conditions which start and/or stop one or more of the tasks of the function referenced by the hook. Optionally, the conditions for starting and/or stopping the one or more tasks may depend on any of the values described above for the “start collection and/or “end collection” parameters. In some embodiments of the invention, the performance of the one or more tasks depends on whether one or more other hooks 20 were encountered. Optionally, API library 13 includes RTstart and RTstop functions which start and end, respectively, the operation of the one or more tasks. Optionally, the RTstart and/or RTstop commands effect all the activated hooks which have conditional operation. Alternatively or additionally, each RTstart and/or RTstop command states the IDs of the hooks to which it pertains. Further alternatively or additionally, for each hook, the activation command states the IDs of hooks which start and/or stop the operation of the one or more tasks. Optionally, the start operations must occur after the hook is activated. Alternatively, the start operation may take effect before the hook is activated, such that immediately when the hook is activated the tasks are operative.

In some embodiments of the invention, the operation condition of the one or more tasks controls one or more parameters of the function. For example, upon activation of a hook the data it logs is stored in a first buffer while after one or more conditions are fulfilled the data is directed to a second buffer.

In some embodiments of the invention, hooks which call control API functions (e.g., RTstop, RTsetFilter) are formed of macros which open into unconditional function calls. Alternatively or additionally, at least some of the hooks which call control API functions are formed of macros which open into conditional function calls. Optionally, some of the control API functions are always called unconditionally and others are always called conditionally. In some embodiments of the invention, one or more of the API functions (control or other) may be called by two different macros, one which opens into a conditional call and another which opens into an unconditional call. Alternatively or additionally, a single macro may open into a conditional or unconditional function call according to a parameter it receives.

In some embodiments of the invention, API library 13 includes one or more fast control functions for use in ISRs or in other time critical routines. Optionally, special buffer 39 includes one or more control flags which are set by the fast control functions when a change in the activation of one or more hooks is requested. When regular API functions (optionally only some of the functions) are called, they optionally check the flags in special buffer 39 to determine whether a change in the activation of the hooks was requested by a fast control function. If a change was requested, the regular API function performs the change before it performs its own task.

In some embodiments of the invention, API library 13 includes one or more buffer control commands which allow control of the buffer from within software application 12. Optionally, similar commands are available to a user of agent manager 19. In some embodiments of the invention, a RTclearBuffer function clears the contents of a specific buffer 28. Optionally, a RTgetBufferSize function retrieves the size of one or more of buffers 26 and/or 28 and/or a RTgetBufferSpace function returns the remaining room in the buffer and/or the utilized room in the buffer. The results of a call to the RTgetBufferSize and/or the RTgetBufferSpace functions may be used in determining the hooks which should be active and/or to set one or more parameters or modes of agent 16 as described hereinbelow.

In some embodiments of the invention, API library 13 comprises an RTgetBufferData function which allows software application 12, generally hooks therein, to review the contents of the buffer. Optionally the contents of the requested buffer are copied to a different area in memory 14 and the function returns a pointer to the data. Alternatively or additionally, the function returns a pointer to the buffer and data collection in the buffer is stopped until a release function is used. Alternatively, data continues to be written to the buffer while it is read by software application 12.

Referring in more detail to agent 16 (FIG. 1), in some embodiments of the invention, agent 16 comprises a pair of tasks for communicating with host 18. One task receives data and commands from host 18 and the other task sends data to host 18. Generally, agent 16 packs the data from buffer 28 into packets and sends the packets to host 18. In addition, agent 16 receives packets from host 18 performs the commands they include and/or places the data they include into buffer 26 (FIG. 4). Agent 16 optionally also manages the communication between host 18 and user application 12. Alternatively or additionally, the communication between the non-logging regular operation tasks of user application 12 and host 18 are handled separately.

The communication between agent 16 and host 18 may be over any type of link known in the art, such as a serial connection via RS-232 communication, a TCP/IP (Transmission Control Protocol/Internet Protocol) connection over a LAN (local area network) or WAN (wide area network) interface, a cellular WAP connection and/or a satellite connection.

Optionally, agent 16 runs on the embedded processor 11 as a low priority task, so that it does not interfere with the running of software applications 12. Alternatively, the data transmitting task runs at a low priority while the data receiving task runs at a higher priority, to allow fast performance of user commands from agent manager 19. Alternatively or additionally, when one or more of buffers 28 (FIG. 4) is nearly full, the priority of agent 16 is automatically raised in order to increase the rate of export of data from the buffers. For example, the dump functions may operate in a mode in which dump data is cyclically written into buffers 28 regardless of whether they are empty or full. When the buffer is nearly full and there is a danger that data will be lost, the priority of agent 16 is increased. Alternatively or additionally, the dump functions operate in a state which does not write data to the buffers 28 when they are full. Further alternatively or additionally, the dump functions write data to buffers 28 even when they are full, but agent 16 keeps track of the amount of data which is lost due to overwriting and this amount of data is brought to the attention of the user.

In some embodiments of the invention, library 13 includes an RTtaskSetPriority function which sets the priority level of the tasks of agent 16. Thus, hooks implanted within software application 12 may change the priority of one or more of the tasks of data transfer agent 16. Alternatively or additionally, a user of agent manager 19 may change the priority of one or more tasks of data transfer agent 16.

In some embodiments of the invention, agent 16 operates in a continuous transfer mode in which agent 16 continuously passes the data from buffers 28 to host 18. That is, each time agent 16 wakes up it checks if there is data in one of buffers 28 and passes the data to host 18. Optionally, data transferred by agent 16 is erased from the buffer 28, for example by moving the beginning pointer of the buffer. Alternatively or additionally, agent 16 operates in a real-time mode in which data is sent by agent 16 to host 18 at specific time intervals or when the buffer is filled above a predefined level or is completely full.

Alternatively or additionally, agent 16 operates in a snapshot mode in which data is transferred by agent 16 to host 18 only after the collection of a chunk of data is completed. For example, data is collected between the operation of an RTstart and an RTstop command and the RTstop command, in addition to deactivating one or more hooks, initiates the transfer of the collected data to host 18. In an exemplary embodiment of the invention, data is collected until a stop command is received from agent manager 19 and then the data is transferred to host 18. Such a stop command maybe activated, for example, by clicking on a stop button in a display of agent manager 19.

Further alternatively or additionally, agent 16 operates in an internal storage mode in which the data from one or more buffers 28 is copied to an internal storage area, optionally in a non-volatile memory, included in embedded device 10. If a system crash occurs, the logging data can be retrieved from the internal storage area. Optionally, when agent 16 is restarted after a system crash of processor 11, the agent checks for data in the internal storage area and if such data is found it is transmitted to host 18. Alternatively to copying the data to the internal storage area by agent 16, in the internal storage mode the data is directly written into the internal storage area by API functions 13.

In some embodiments of the invention, the user of agent manager 19 can set the mode in which agent 16 operates. Alternatively or additionally, API library 13 includes one or more functions which set the operation mode of agent 16.

In some embodiments of the invention, agent 16 transfers the data from one or more buffers 28 simultaneously to a plurality of locations. For example, the data may be stored internally, transmitted to a local host 18 and transmitted over a satellite link to a remote central control station. Alternatively or additionally, agent 16 may operate in different transmission modes with respect to different buffers 28 and the data of different buffers 28 may be transmitted to different locations.

In some embodiments of the invention, one or more of the lists 32 and/or 36 of active hooks is changed responsive to a change in the data transfer mode of agent 16 and/or responsive to the operability of a link to host 18. In an exemplary embodiment of the invention, a separate set of lists 32 and 36 is prepared for cases in which the connection between host 18 and agent 16 is inoperable. These special hook links may collect, for example, only very important data. Alternatively, they may collect much more data. The collected data may remain in buffers 28 until the connection to host 18 is reestablished or may be stored in an internal non-volatile memory (e.g., a hard disk, CD, EPROM, etc.).

In some embodiments of the invention, API library 13 includes one or more start-up functions. In an exemplary embodiment of the invention, the start-up functions include an RTintModule function which creates a registry record 22 for a software application. Optionally, each software application 12 calls the RTinitModule function when it starts up.

In some embodiments of the invention, the start-up functions include a RTinitAgent function which performs start-up tasks which are performed once for all software applications 12 running on embedded processor 11. Such start up tasks may include for example loading and initializing data transfer agent 16 and allocating memory for logging area 17. Optionally, a predetermined amount of memory is allocated for each of the elements of logging area 17. Alternatively, the call to the RTinitAgent function may include user selected values for the various elements of logging area 17. Alternatively or additionally, some or all of the memory allocation is performed separately for each software application 12, optionally, by the RTinitModule function.

In some embodiments of the invention, buffers 28 are implemented as cyclic FIFO (first in, first out) queues. Alternatively or additionally, one or more of buffers 28 are implemented using other types of data structures, such as linked lists. In some embodiments of the invention, the boundaries between the buffers 28 of different software applications 12 may be changed dynamically according to the amount of logging data produced by each of the applications and/or the importance of the logged data.

Alternatively, to using a single function RTinitAgent to perform all the start-up tasks which are common to all the software application 12, the tasks are distributed among a plurality of functions which are called at different stages of the startup of embedded processor 11. In an exemplary embodiment of the invention, a first start-up function RTinitCollection) initializes logging area 17 and allows logging of data. A second start-up function (RTinitCommunication) initializes the communication between embedded processor 11 and host 18. Thus, logging data may be collected before a communication link is established between embedded processor 11 and host 18 or any external communication link is established. This is especially useful when it is required to debug start-up procedures running on embedded processor 11.

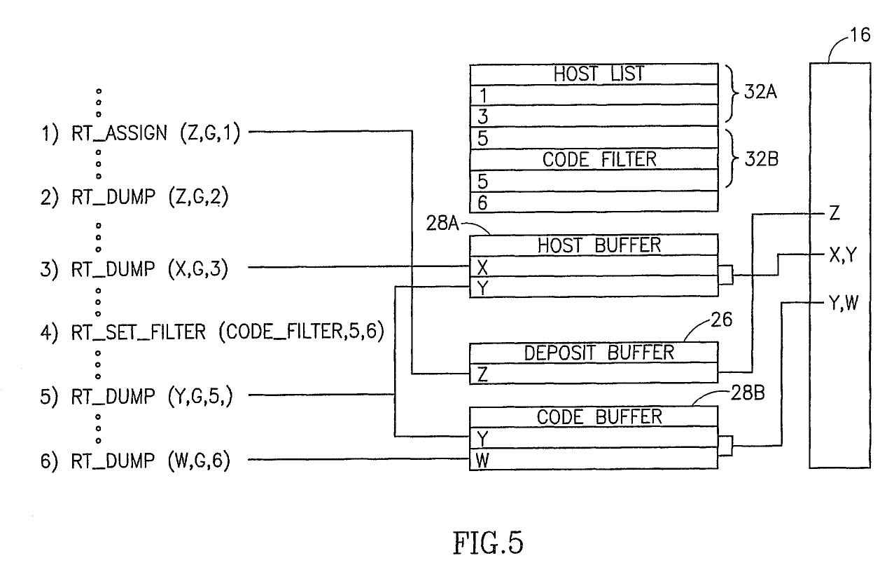

Reference is now made to FIG. 5, which is a schematic block-diagram illustration of exemplary code appearing in a software application 12 and data flows relating thereto, in accordance with an embodiment of the present invention. Logging area 17 comprises two hook lists, a host list 32A and a code list 32B. In addition, logging area 17 comprises two respective buffers, a host buffer 28A and a code buffer 28B.

The example of FIG. 5 begins with host filter 32A including the hook IDs 1, 3 and 5. Code filter 32 begins empty. At some point before the beginning of the example, a value for a variable Z is received from agent manager 19 by transfer agent 16. Agent 16 placed the value in deposit buffer 26. When hook 1 RTassign(Z, G, 1) is reached, the RTassign function is called since hook 1 is active in host list 32A. The RTassign function retrieves the value of Z from buffer 26 and places the value in variable Z of software application 12. If a value for Z was not received from agent manager 19, user application 12 continues its execution with the current value of Z.

When hook 2, RTdump(Z, G, 2), is reached, ID 2 is not active in any of filters 32 and therefore the RTdump function is not called. When hook 3, RTdump(X G, 3), is reached, hook 3 is active in host list 32A and therefore the RTdump function is called. The RTdump function determines that hook 3 is active only in host list 32A and therefore the value of X is dumped only into host buffer 28A. hook 4 is an RTsetFilter command which in the example of FIG. 5 is called unconditionally. In the example, RTsetFilter changes code list 32B by adding hooks 5 and 6 to the active list. Thus, when hook 5 (RTdump(Y, G, 5)) is reached, hook 5 is active in both of lists 32A and 32B and therefore the RTdump function puts the value of Y into both of buffers 28A and 28B. When hook 6 (RTdump(W, G, 6)) is encountered, the dump function is called and puts the value of W into buffer 28B, as hook 6 is active only in list 32B.

At some point, depending on the data transfer mode of agent 16, agent 16 transmits the data in buffers 28 to host 18.

An exemplary code fragment showing a possible use of RTstart and RTstop follows.

If(CPUUsagePercent> 80)

RTstart(0)

try{
...
} catch(){

RTstop(1)

}

If CPU usage is above 80 percent, a possible sign of system instability, data collection is started. On entering a program-error handling routine, such as a catch, the data collection is stopped.

It will be appreciated that the above described methods may be varied in many ways, including, changing the order of steps and/or performing some steps in parallel. For example, a compiled software application 12 may be loaded concurrently to host 18 and to embedded processor 11. It should also be appreciated that the above described description of methods and apparatus are to be interpreted as including apparatus for carrying out the methods and methods of using the apparatus. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments may describe a best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A generic software logging package for using with a user software application, comprising:
at least one function which stores logging data into at least one logging buffer; and
at least one macro command which expands into a conditional call to the at least one function, the conditional call including a call statement which transfers to the called function at least one redundant parameter.

2. A software logging package according to claim 1, comprising a data transfer agent which transfers data from the at least one logging buffer to a remote host.

3. A software logging package according to claim 1, wherein the at least one redundant parameter comprises a string parameter which provides information relating to the macro command in an ASCII format.

4. A software logging package according to claim 1, wherein the at least one redundant parameter comprises a parameter which identifies the location of the macro command in the user software application.

5. A software logging package according to claim 1, wherein the at least one redundant parameter comprises a parameter which identifies a variable whose value is to be logged by the at least one function.

6. A software logging package according to any of the preceding claims, wherein the at least one redundant parameter comprises a parameter which identifies the existence of the macro command in the user software application.

7. A method of preparing a user software application for debugging, comprising:
annexing to the user software application at least one function which stores logging data into at least one logging buffer;
inserting at least one hook, which includes a call statement to the at least one function, to the user software application;
compiling the user software application; and
determining one or more parameters of the at least one hook from the compiled user software application.

8. A method according to claim 7, wherein determining the one or more parameters comprises determining by a software which does not have knowledge of the format of the results of the compiling of the user software application.

9. A method according to claim 7, wherein determining the one or more parameters comprises determining a type of a variable whose value is logged by the at least one annexed function.

10. A method according to claim 7, wherein inserting the at least one hook comprises inserting a macro.

11. A method according to claim 7, wherein inserting the at least one hook comprises inserting a hook that includes a string which includes information on the hook in ASCII format.

12. A method according to any of claims 7-11, wherein the at least one hook comprises a conditional call to the at least one function, wherein the conditional call comprises at least two sub-conditions which depend on respective separate parameters.

13. A method according to claim 12, wherein the at least one function is called by the at least one hook if one of the sub-conditions is fulfilled.

14. A method according to claim 12, wherein the at least one function is called by the at least one hook only if both the sub-conditions are fulfilled.

15. A method of preparing a user software application for debugging, comprising:
annexing to the user software application at least one function which performs a debugging task; and
inserting at least one hook, which includes a conditional call statement to the at least one function, to the user software application, wherein the conditional call comprises at least two sub-conditions which depend on respective different parameters.

16. A method according to claim 15, wherein the at least one function is called by the at least one hook if one of the sub-conditions is fulfilled.

17. A method according to claim 15, wherein the at least one function is called by the at least one hook only if both the sub-conditions are fulfilled.

18. A method according to any of claims 15-17, wherein the at least one hook has a unique ID and wherein the at least one of the sub-conditions comprises a condition on the unique ID.

19. A method according to any of claims 15-17, wherein the at least one hook belongs to a group of hooks having a unique group ID and wherein at least one of the sub-conditions comprises a condition on the group ID.

20. A method of preparing a user software application for debugging, comprising:
annexing to the user software application at least one function which performs a debugging task;
inserting, into the user software application, at least one hook, which includes a conditional call statement to the at least one function; and
providing a plurality of different functions which actuate the conditional call to call the at least one debugging function.

21. A method according to claim 20, wherein providing the plurality of different functions comprises providing a first function which is called from within the user software application and a second function which is called from a host in communication with apparatus running the user software application.

22. A method of preparing a user software application for debugging, comprising:
annexing to the user software application at least one debugging function which performs a debugging task;
inserting, into the user software application, at least one debugging hook that includes a conditional call to the at least one debugging function;
annexing to the user software application at least one actuation function which changes a value of at least one condition parameter on which the condition of the at least one debugging hook depends; and
inserting, into the user software application, at least one actuation hook which calls the actuation function.

23. A method according to claim 22, wherein the at least one actuation hook conditionally calls the actuation function.

24. A method according to claim 22, wherein the at least one actuation hook unconditionally calls the actuation function.

25. A method according to claim 22, wherein the at least one actuation function receives a condition which controls the time at which the value of the at least one condition parameter is changed.

26. A method according to claim 22, wherein the at least one debugging function comprises one or more debugging tasks which are performed only in some of the times in which the debugging function is called.

27. A method according to claim 26, wherein the at least one actuation function receives a condition which controls the operation periods of the one or more debugging tasks.

28. A method according to claim 25 or 27, wherein the received condition comprises a condition which depends on whether the user software application encountered one or more hooks inserted into the user software application.

29. A method according to claim 28, wherein the received condition comprises a condition which depends on whether the user software application encountered the one or more specific hooks after the debugging hook was activated.

30. A method according to claim 25 or 27, wherein the debugging function comprises a logging function.

31. A method according to claim 30, wherein the received condition comprises a condition which depends on the contents of one or more buffers in which the logging function writes data.

32. A method according to claim 31, wherein the received condition comprises a condition which depends on whether the one or more buffers are full.

33. A method according to claim 25 or 27, wherein the received condition comprises a condition which depends on an activation state of a link between a processor running the user software application and a remote host.

34. A method according to claim 25 or 27, comprising changing the value of the condition parameter by an external user.

35. A method according to claim 34, wherein the debugging function operates differently depending on whether the change of the value of the condition parameter was caused by the external user or by the actuation function.

36. A method according to claim 35, wherein the different operation comprises the identity of one or more buffers to which the debugging function writes logging data.

37. A method of preparing a user software application for debugging, comprising:
annexing, to the user software application, a first logging function which is adapted to store logging data in a first buffer; and
annexing, to the user software application, a second logging function adapted to transfer any data in the first buffer to a second buffer and then store logging data in the second buffer.

38. A method according to claim 37, wherein access to the first buffer is not protected by a software synchronization mechanism.

39. A method according to claim 37 or 38, wherein the size of the first buffer is not greater than 40 bytes.

40. A method of preparing a user software application for debugging, comprising:
annexing to the user software application at least one debugging function which performs a debugging task;
inserting, into the user software application, at least one debugging hook that includes a conditional call, which depends on a debugging condition variable, to the at least one debugging function;
annexing to the user software application at least one callback function which calls a user defined function;
inserting, into the user software application, at least one callback hook that includes a conditional call, which depends on a callback condition variable, to the at least one debugging function; and
providing at least one routine adapted to change both the callback condition variable and the debugging condition variable.

41. A method according to claim 40, wherein the at least one routine changes the debugging condition variable and the callback condition variable substantially concurrently.

42. A method according to claim 40, wherein the at least one routine changes at a specific routine call, one of the debugging condition variable and the callback condition variable.

43. A method according to claim 40, wherein the at least one routine changes the debugging condition variable and the callback condition variable responsive to commands from a remote host.

44. A method according to any of claims 40-43, wherein the at least one routine changes the debugging condition variable and the callback condition variable responsive to commands annexed to the user software application.

45. A method of changing the value of a portion of a complex variable in a process running on an embedded device, from a remote host, comprising:
providing a new value to which the portion of the complex variable is to be changed;
encapsulating the new value in a data structure of the size of the complex variable;
generating a mask which identifies the areas in the data structure which include the new value;
transmitting the data structure and the generated mask to the embedded device; and
changing the value of the portion of the complex variable responsive to the data structure and the mask.

46. A method according to claim 45, wherein changing the value of the portion of the complex variable comprises performing an AND operation between the mask and the complex variable.

47. A method of changing, substantially simultaneously, the value of a plurality of variables of a plurality of different processes executed by a processor, comprising:
providing respective values to be assigned to the plurality of variables, to the processor;
calling a value assignment function from a first one of the processes;
stalling the first process until all the other processes call the assignment function;
assigning the transmitted values to their respective variables; and
terminating the stalling of the first process.

48. A method according to claim 47, wherein assigning the value of the variable in the first process is performed before the first process is stalled.

49. A method according to claim 47, wherein assigning the value of the variable in the first process is performed after the stalling of the first process is terminated.

50. A method according to claim 47-49, wherein providing respective values to the processor comprises transmitting the values to the processor from a remote host.

51. A method of logging data of a software application on an embedded device, comprising:
calling a logging function from one or more first hooks in the software application;
storing, by the logging function, logging data in a first buffer responsive to the call from the one or more first hooks;
calling the same logging function from one or more second hooks in the software application; and
storing logging data, by the same logging function, in a second buffer responsive to the call from the one or more second hooks.

52. A method according to claim 51, wherein the first and second hooks are activated by different respective software routines.

53. A method according to claim 51, wherein the first hooks are activated responsive to a command annexed to the software application and the second hooks are activated responsive to commands from a remote host.

54. A method according to claim 51, comprising providing at least some of the data from the first and second buffers to a user, using different respective methods.

55. A method according to claim 54, wherein the different methods used to provide data from the respective buffers to the user differ in the link used to provide the data.

56. A method according to claim 55, wherein the data from the first buffer is stored in a non-volatile memory and the data from the second buffer is provided over a communication link to a remote host.

57. A method according to any of claims 51-56, comprising calling a logging function from one or more third hooks in the software application and storing, by the logging function, logging data in one or more additional buffers responsive to the call from the one or more third hooks.

58. A method of logging data of a software application on an embedded device, comprising:
calling a logging function from a hook in the software application; and
storing, by the logging function, identical copies of logging data in a plurality of buffers responsive to the call from the hook.

59. A method according to claim 58, wherein storing the data comprises storing in a plurality of buffers located in a single memory unit.
